(19) United States
(12) Patent Application Publication
(10) Pub. No.: US 2012/0202976 A1
(43) Pub. Date: Aug. 9, 2012

(54) SEPARATION MATRICES

(75) Inventors: Andreas Axen, Uppsala (SE); Eggert Brekkan, Uppsala (SE); Gunilla Edgren, Uppsala (SE); Gunnar Malmquist, Uppsala (SE)

(73) Assignee: GE HEALTHCARE BIO-SCIENCES AB, UPPSALA (SE)

(21) Appl. No.: 13/501,623

(22) PCT Filed: Oct. 8, 2010
(86) PCT No.: PCT/SE2010/051088

§ 371 Date: Apr. 12, 2012

(30) Foreign Application Priority Data
Oct. 12, 2009 (SE) 0950748-4

(51) Int. Cl. C07K 1/14; C08B 37/00; C08B 37/02

(52) U.S. Cl. 530/388.1; 536/112; 536/123.1

(57) ABSTRACT

The present invention relates to separation matrices comprising base matrices with first ligands comprising hydrophobic functions covalently bound to said base matrices and with extenders covalently bound to said base matrices, said extenders comprising second ion exchange ligands.

### TECHNICAL FIELD

The present invention relates to separation matrices useful for separation of biomolecules, to methods to prepare the separation matrices and to methods of using the separation matrices for separation of biomolecules.

### BACKGROUND OF THE INVENTION

There are many instances when it is required to separate one compound, such as an impurity or a desired molecule, from a liquid or from other solid materials. Charge-charge based interactions are used in a number of fields to capture and hence separate charged or chargeable compounds.

In the chemical and biotech field, target compounds such as drug or drug candidates usually need to be separated from contaminating species originating from the process of manufacture. For example, a protein drug or drug candidate produced by expression of recombinant host cells will need to be separated e.g. from the host cells and possibly cell debris, other host cell proteins, DNA, RNA, and residues from the fermentation broth such as salts. Due to its versatility and sensitivity to the target compounds, chromatography is involved as at least one step in many of the currently used biotech purification schemes. The term chromatography embraces a family of closely related separation methods, which are all based on the principle that two mutually immiscible phases are brought into contact. More specifically, the target compound is introduced into a mobile phase, which is contacted with a stationary phase. The target compound will then undergo a series of interactions between the stationary and mobile phases as it is being carried through the system by the mobile phase. The interactions exploit differences in the physical or chemical properties of the components of the sample.

The stationary phase in chromatography is comprised of a base matrix to which ligands, which are functional groups capable of interaction with the target compound, have been coupled. Consequently, the ligands will impart to the carrier the ability to effect the separation, identification, and/or purification of molecules of interest. Liquid chromatography methods are commonly named after the interaction principle utilized to separate compounds. For example, ion exchange chromatography is based on charge-charge interactions; hydrophobic interaction chromatography (HIC) utilizes hydrophobic interactions; and affinity chromatography is based on specific biological affinities. More than one interaction principle may also be used simultaneously, such as in multimodal chromatography where, most commonly, ligands with ion exchange functionality together with one more functionality (e.g. hydrophobic) are used.

As is well known, ion exchange is based on the reversible interaction between a charged target compound and an oppositely charged chromatography matrix. The elution is most commonly performed by increasing the salt concentration, but changing the pH is equally possible. Ion-exchangers are divided into cation-exchangers, wherein a negatively charged chromatography matrix is used to adsorb a positively charged target compound; and anion-exchangers, wherein a positively charged chromatography matrix is used to adsorb a negatively charged target compound. The term “strong” ion exchanger is used for an ion-exchanger which is charged over broad pH intervals, while a “weak” ion-exchanger is chargeable at certain pH values. One commonly used strong cation-exchanger comprises sulfonate ligands, known as S groups. In some cases, such cation exchangers are named by the group formed by the functional group and its linker to the carrier; for example SP cation exchangers wherein the S groups are linked by propyl (P) to the carrier.

The properties of the base matrix will also affect the separation properties of a chromatography matrix. Hydrophilic base matrices (e.g. polysaccharides) give very low intrinsic protein adsorption, while hydrophobic base matrices such as styrenic or methacrylate polymers need a hydrophilic surface modification to prevent protein adsorption in most separation techniques. The surface modification is a complicating factor and may contribute to batch to batch variation in manufacturing. A further consideration of the base matrix is the ease of which it is functionalized. Depending on the chemistry used for coupling ligands, the base matrix may be activated i.e. transformed into a more reactive form. Such activation methods are well known in this field, such as allylation of the hydroxyl groups of a hydrophilic base matrix, such as a polysaccharide. Covalent ligand attachment is typically achieved by the use of reactive functionalities on the base matrix such as hydroxyl, carboxyl, thiol, amino groups, and the like. The ligand is normally attached to the base matrix via a linking arm known simply as the linker. This linker can be either a result of the coupling chemistry used or a structure deliberately introduced to improve the steric accessibility of the ligand. In either case the length of the linker is normally less than about ten atoms.

It is also known to incorporate extenders in separation matrices, particularly in ion exchange matrices. The extender is a polymeric species attached to the base matrix, with ion exchange ligands on the polymer chain, either evenly or randomly spread over the chain or in specific locations. The use of extenders has been found to increase the dynamic binding capacity for proteins and other biomolecules, possibly due to the involvement of solid diffusion phenomena. WO2007027139 (GE Healthcare) describes separation matrices prepared by coupling dextran extenders to agarose base matrices and then reacting the matrices with sodium vinylsulphonate to couple sulphonate cation exchange ligands on the extenders. This construction has a high rigidity and shows a high dynamic protein capacity. In certain applications, such as e.g. separation of monoclonal antibodies, there is however a need for more specific binding of particular biomolecules in order to achieve higher purity after the ion exchange step.

WO2008145270 (Merck Patent) describes separation matrices prepared by graft polymerizing a mixture of charged and hydrophobic monomers to polymethacrylate base matrices. This construction gives extenders having both charged and hydrophobic groups on the extenders which improves the specificity for monoclonal antibodies, but does not give a high dynamic capacity. A high dynamic capacity is desirable as it provides for a high process throughput. Hence, there is a need for new matrices giving high purity and high throughput as well as being suitable for reproducible manufacturing.

### BRIEF DESCRIPTION OF THE INVENTION

One aspect of the present invention is to provide new separation matrices capable of providing high purity in high throughput processes. This is achieved with separation matrices comprising base matrices with first ligands comprising hydrophobic functions covalently bound to said base matrices and with extenders covalently bound to said base matrices, said extenders comprising second ion exchange ligands.

A specific aspect of the invention is a method to manufacture new separation matrices capable of providing high purity in high throughput processes. This is achieved by a method comprising a) coupling ligands comprising hydrophobic functions to base matrices and b) coupling extenders comprising ion exchange ligands to said base matrices. These operations may be carried out in any order.

A further aspect of the invention is an alternative method to manufacture new separation matrices capable of providing high purity in high throughput processes. This is achieved by a method comprising (in any order) a) coupling ligands comprising hydrophobic function to base matrices, b) coupling extenders to said base matrices and c) coupling ion exchange ligands to said extenders.

A further aspect of the invention is another alternative method to manufacture new separation matrices capable of providing high purity in high throughput processes. This is achieved by a method comprising (in any order) a) coupling ligands comprising hydrophobic functions to base matrices and b) graft polymerizing monomers comprising charged monomers to said base matrices.

A specific aspect of the invention is a method to separate at least one target biomolecule from a liquid preparation to a high purity and with high throughput. This is achieved by a method which includes a step of contacting said liquid preparation with separation matrices comprising first ligands comprising hydrophobic functions covalently bound to the base matrices and extenders comprising second ion exchange ligands.

One or more of the aspects above may be achieved by the present invention as defined by the appended claims. Additional aspects, details and advantages of the invention will appear from the detailed description and claims that follow.

### BRIEF DESCRIPTION OF THE DRAWINGS

FIG. 1 shows how the content of n-butyl ligands affects dynamic IgG capacity and residual host cell protein levels for an antibody feed after treatment with the separation matrices of the invention.

FIG. 2 shows how the content of n-butyl ligands affects residual Gentamicin levels in an antibody feed after treatment with the separation matrices of the invention.

### DEFINITIONS

The term “target compound” means herein any compound, molecule or other entity one wishes to isolate from an aqueous solution. The target compound may be the desired product, or an undesired impurity of a liquid product. If the target compound is a biomolecule, it may be called target biomolecule.

The term “impurity” means herein any undesired compound, molecule or other entity present in a liquid or in a solid material.

The term “polyhydroxy polymer” means herein any polymer comprising a multitude of hydroxyl groups.

The term “polysaccharide” includes as used herein natural polysaccharides, synthetic polysaccharides, polysaccharide derivatives, modified polysaccharides, and any mixture thereof.

The term “ligand” is used herein in its conventional meaning in chromatography for an entity comprising a functional group capable of interaction with a target compound. Examples of groups of ligands are positively charged or chargeable groups (anion exchange ligands); negatively charged or chargeable groups (cation exchange ligands); hydrophobic groups; groups with a specific biological affinity for a target compound, such as the affinity of an antigen for an antibody (affinity ligands); etc.

The term “extender” means herein a polymer, covalently attached in at least one point to a base matrix. Ion exchange ligands are either covalently bound to the extender or form an integral part of the extender polymer. Extenders are also known e.g. as “flexible arms”, “tentacles” and sometimes “fluff”. In this context, an extender is distinguished from a linker in that the extender is a polymeric species, which the linker is not.

The term “base matrix” means herein any solid material, also known as support or carrier, suitable for use in separation methods such as chromatography, batch adsorption or membrane separations.

The term “hydrophobic function” means herein that the ligand has a moiety able to interact with solutes via hydrophobic interactions. Examples of ligands comprising hydrophobic function are the ligands used in hydrophobic interaction chromatography (HIC).

The term “biomolecule” means herein a member (including synthetic or semi-synthetic members) of any class of substances that may be produced by a biological organism. Examples of such classes are peptides, proteins, carbohydrates, nucleic acids, plasmids, viruses and cells.

“Protein” refers to any type of protein, glycoprotein, phosphoprotein, protein conjugate, protein assembly or protein fragment. Antibodies constitute a commercially important class of proteins.

Other proteins of commercial interest are peptides, insulin, erythropoietin, interferons, enzymes, plasma proteins, bacterial proteins, virus-like particles etc.

“Antibody” refers to any immunoglobulin molecule, antigen-binding immunoglobulin fragment or immunoglobulin fusion protein, monoclonal or polyclonal, derived from human or other animal cell lines, including natural or genetically modified forms such as humanized, human, chimeric, synthetic, recombinant, hybrid, mutated, grafted, and in vitro generated antibodies. Commonly known natural immunoglobulin antibodies include IgA, IgG, IgE, IgG and IgM.

The term “desorption liquid” means herein a liquid (typically a buffer) of such composition (pH, ionic strength, concentration of other components) that it causes the target biomolecule to desorb from the separation matrix. In liquid chromatographic separations, the desorption buffer is commonly called elution buffer or eluent.

The term “dynamic binding capacity” means herein the amount of a test species, such as a protein, a separation matrix is capable of binding in a breakthrough test.

### DETAILED DESCRIPTION OF THE INVENTION

One aspect of the present invention relates to separation matrices comprising base matrices with first ligands comprising hydrophobic functions covalently bound to said base matrices and with extenders covalently bound to said base matrices, said extenders comprising second ion exchange ligands. One advantage of the invention is that the combination of extenders and hydrophobic ligands on the base matrices surprisingly gives a high selectivity for proteins like monoclonal antibodies in combination with a high dynamic protein capacity. It is also possible to fine-tune the selectivity by varying the amount and/or type of ligands comprising hydrophobic functions.

In one embodiment the ligands comprising hydrophobic functions comprise at least one C₂-C₁₈ hydrocarbon chain (linear or branched), such as a C₄-C₁₈ hydrocarbon chain, or at least one hydrocarbon ring. Both the hydrocarbon chain and the hydrocarbon ring may be terminal, i.e.

attached in only one point to either the residual ligand structure or the linker. They may also be unsubstituted, i.e. having no non-hydrocarbon substituents apart from the attachment to the residual ligand structure/linker. Specifically, they may be in the form of butyl, hexyl, octyl or phenyl groups. In one embodiment the ligands comprising hydrophobic function have only hydrophobic function. They may consist of saturated hydrocarbon chains and/or aromatic rings, optionally substituted with ether and/or hydroxyl groups.

In another embodiment the extenders comprise polymers of average molecular weight ≧1000 Da such as over 10 000 Da or even over 30 000 Da. These polymers may be may be linear or branched, substituted or non-substituted, natural or synthetic. They may comprise reactive groups for coupling of ion exchange ligands and/or they may inherently comprise ion exchange ligands either as substituents or as components of a backbone chain. Examples of extender polymers are the groups of polyvinyl ethers, polyacrylates, polymethacrylates, polyacrylamides, polymethacrylamides etc. In one embodiment the extenders comprise polyhydroxy polymers, where one group of polyhydroxy polymers contemplated is polysaccharides, e.g. dextran, pullulan, starch, cellulose derivatives etc. Another group of polyhydroxy polymers is synthetic polymers like polyvinyl alcohol, polyhydroxyalkyl vinyl ethers, polyhydroxyalkyl methacrylates, polyglyceryl methacrylate and glycidyl methacrylate polymers reacted with diols or polyols.

In one embodiment the base matrices comprise crosslinked polyhydroxy polymers. These polyhydroxy polymers may be of synthetic or natural origin. One group of natural polyhydroxy polymers contemplated is polysaccharides, such as cellulose, dextran or thermally gelling polysaccharides, e.g. agarose or agar. Examples of synthetic polyhydroxy polymers include the groups of polyvinyl alcohol, polyhydroxyalkyl vinyl ethers, polyhydroxyalkyl methacrylates, polyglyceryl methacrylate and glycidyl methacrylate polymers reacted with diols or polyols. One advantage of base matrices prepared from polysaccharides and other polyhydroxy polymers is that they are intrinsically hydrophilic, i.e. that in unsubstituted form they give no or very low protein adsorption. This allows for good control and reproducibility of ligand-functional matrices, as the interactions with biomolecules are essentially only affected by the ligands that can be coupled with good precision.

In a further embodiment the ion exchange ligands comprise cation exchange ligands such as sulfonate, sulphate, carboxyl or phosphate groups. In an alternative embodiment the ion exchange ligands comprise anion exchange ligands, e.g. quaternary ammonium groups or tertiary amines.

In one embodiment the total amount of ion exchange ligands on the separation matrices is 25-250 micromol per ml matrix, such as 50-150 micromol/ml matrix or 75-125 micromol/ml matrix.

In another embodiment, the extenders comprise no or low amounts of ligands comprising hydrophobic functions. This amount may be less than 5 micromol/g hydrophobic ligands (calculated per g extender) or even substantially zero. The skilled person will realize that even if the manufacturing method has been directed not to give any hydrophobic ligands at all on the extenders, spurious hydrophobic ligands may still be attached to the extenders. Provided that their amount is low, such as below 5 or 2 micromol/g extender, these few ligands will not be detrimental to the protein capacity or other chromatographic properties. Having a low or essentially zero amount of hydrophobic ligands on the extender is advantageous for the protein capacity of the separation matrices.

In one embodiment, the amount of ligands comprising hydrophobic functions on the separation matrices is 10-100 micromol/ml separation matrix such as 20-70 micromol/ml separation matrix. This can be measured by methods known in the art, such as NMR, vibrational spectroscopy, pyrolysis GC etc.

In a further embodiment the ligands comprising hydrophobic functions are attached to the base matrices via linkers comprising ether and hydroxyl groups. Such linkers are hydrolytically stable and are conveniently prepared through coupling via epoxy or halohydrin chemistries. Examples of linkers contemplated are glyceryl ether, diglyceryl ether and glyceryl-butylene-glyceryl ether.

In one embodiment the dynamic IgG binding capacity (QB10%) of the separation matrices is 100 mg/ml matrix. This can be determined in a breakthrough test where the matrix is confined in a column or membrane adsorber device. Buffered IgG solution is pumped through the column/adsorber and the protein concentration in the effluent is monitored with respect to UV absorbance. When the effluent protein concentration reaches 10% of the concentration in the feed, the total amount of IgG fed to the column/adsorber is calculated, divided with the volume of the matrix and reported as the 10% breakthrough capacity. Details of a suitable experiment for QB 10% determination are given in Example 2.

In certain embodiments the separation matrices have a specific shape. They can e.g. be in the form of particles, membranes or monolithic porous materials. When they are in the form of particles, these particles may be spherical, substantially spherical or irregularly shaped and porous or non-porous. The particles may have various morphologies and may contain materials able to interact with an external force field, e.g. magnetic (superparamagnetic) or high density materials. In one embodiment the separation matrices are porous, with an average pore diameter>50 nm and/or a porosity>80%, which is advantageous for the mass transport of e.g. proteins in the matrices.

One aspect of the invention relates to a method to manufacture separation matrices. In one embodiment this method comprises a) coupling first ligands comprising hydrophobic function to base matrices and b) coupling extenders comprising second ion exchange ligands to said base matrices. An advantage of this method is that the ion exchange ligands will be located only on the extender. The steps may be carried out in any order, but in one embodiment step a) is carried out before step b) in order to avoid having any hydrophobic ligands on the extender. Step a) may involve either the direct reaction between ligand reagents and reactive groups such as hydroxyls, carboxyls, amines, aldehydes and the like on the base matrices or an activation of reactive groups on the base matrices with activation reagents and subsequent reaction with ligand reagents. Examples of ligand reagents are epoxides, halohydrins, amines, carboxyls, and carboxy halogens that comprise hydrophobic functions. Examples of activation reagents known in the art are: epichlorohydrin, bisepoxides, chlorotriazine, cyanogen halides, allylation or vinylation reagents (e.g. allyl halides or allyl glycidyl ether) combined with halogens, tosyls, tresyls or other leaving groups. In step b) it is possible to either couple reactive extenders (having epoxide, halohydrin, amine, aldehyde etc. functionalities) to reactive groups on the base matrices or to first activate the base matrices and then react with the extender polymers.

In another embodiment the manufacturing method comprises a′) coupling first ligands comprising hydrophobic functions to base matrices, b′) coupling extenders to said base matrices and c′) coupling second ion exchange ligands to said extenders. The steps may be carried out in any order, but in one embodiment step a′) is carried out before step b′) or c′). In a specific embodiment step a) is carried out before step b′), which is carried out before step c′), in order to avoid having any hydrophobic ligands on the extender. Steps a′) and b′) may be carried out as a) and b) above, while step c′) may involve reactions between charged reagents and reactive groups on the extender polymers. Examples of charged reagents are sulfite ions, vinylsulfonic acid, amines (e.g. trimethylamine), glycidyltrimethylammonium chloride, diethylaminoethyl chloride, chloroacetic acid, bromoacetic acid etc., while examples of reactive groups on the extenders are epoxides, halohydrins, double bonds, hydroxyls, amines etc.

In one embodiment the manufacturing method comprises a″) coupling ligands comprising hydrophobic functions to base matrices and b″) graft polymerizing monomers comprising charged monomers to said base matrices. The steps may be carried out in any order, but in one embodiment step a″) is carried out before step b″) in order to avoid having any hydrophobic ligands on the extender. Step a″) may be carried out as a) or a′) above. Graft polymerization is a well known technology and several different techniques are known. In the “grafting from” technique, initiating sites are created on the base matrices, using e.g. cerium (IV) salts, Fe²⁺/H₂O₂, copper (I) salts, UV-irradiated benzophenones, ionizing radiation etc. Monomers will then react with the initiating sites and propagate so that polymer chains covalently bound to the base matrices are formed. In the “grafting through” technique, copolymerizable groups such as vinyl, allyl, acryl or methacryl groups are coupled to the base matrices. The matrices are then contacted with monomers and polymerization is initiated so that the monomers copolymerize with the coupled polymerizable groups.

In one embodiment the ligands comprising hydrophobic functions are coupled to the base matrices by reacting the base matrices with alkyl or alkylaryl glycidyl ethers. Examples of alkyl glycidyl ethers are ethyl glycidyl ether, n-propyl glycidyl ether, isopropyl glycidyl ether, n-butyl glycidyl ether, isobutyl glycidyl ether, t-butyl glycidyl ether, pentyl glycidyl ether (all isomers), hexyl glycidyl ether (all isomers), cyclohexyl glycidyl ether, heptyl glycidyl ether (all isomers), octyl glycidyl ether (all isomers), decyl glycidyl ether etc. Examples of alkylaryl glycidyl ethers are phenyl glycidyl ether, benzyl glycidyl ether etc.

One aspect of the invention relates to a method to separate at least one target biomolecule from a liquid preparation, which includes a step of contacting said liquid preparation with separation matrices comprising first ligands comprising hydrophobic functions covalently bound to the base matrices and extenders comprising second ion exchange ligands. In one embodiment the base matrices comprise agarose and in another embodiment the extenders comprise dextran. In yet another embodiment the ion exchange ligands comprise cation exchange ligands.

In one embodiment the target biomolecule is a protein such as an antibody. Antibodies are industrially important proteins and the matrices of the invention show surprisingly high selectivity and capacity towards antibodies.

In one embodiment the target biomolecule binds to the separation matrices while non-binding/less strongly bound impurities are washed or desorbed from the matrices before contacting the matrix with a desorption liquid to desorb the target biomolecule. When carried out in a column, this mode is also called bind-elute chromatography and it offers ample possibilities to optimize the selectivity of the separation step by the choice of different buffers (binding buffer, washing buffer and desorption buffer) and the optional use of buffer gradients for desorption. In an alternative embodiment both the target biomolecule and impurities bind to the separation matrices, which are subsequently contacted with a desorption liquid that selectively desorbs the target biomolecule. Remaining impurities on the matrices can then be desorbed with a regeneration liquid before reuse of the separation matrices. Alkaline solutions such as 0.1 M-2 M NaOH can be used as regeneration liquids but it is also possible to use other liquids.

In one embodiment the desorption liquid has a different conductivity and/or pH than the binding buffer and the washing buffer, such as a higher conductivity than the binding buffer and the washing buffer.

In another embodiment the liquid preparation contains host cell proteins. Whenever a biomolecule is expressed in cells, the cells will also express their own proteins, usually called host cell proteins (HCP). This is a broad range of different proteins, depending on the cell type and remaining HCP is an impurity class that is often difficult to remove in downstream processing. When CHO cells are used for expression of proteins (e.g. monoclonal antibodies), the host cell proteins are sometimes called CHO cell proteins (CHOP). Efficient removal of HCP/CHOP is a desirable feature. In one embodiment the host cell protein concentration is reduced by a factor of 5 or even 10 in the separation step. Methods to determine HCP/CHOP levels before and after the separation step are well known and include e.g. immunoassays.

In another embodiment the separation matrices are packed in a column There are many different column constructions available commercially and methods for packing columns with separation matrices in particle form are well known in the art.

In a further embodiment the impurities bind to the separation matrices, while the target biomolecule is recovered in the flow-through of the column This method is often called flow-through chromatography and gives a high throughput, particularly if the impurity levels are relatively low (e.g. below 10 000 ppm).

In one embodiment a suspension of separation matrix particles is contacted with the liquid preparation and the separation matrix particles are subsequently removed from the liquid preparation. This method is often used in batch mode, but continuous modes can also be employed. In one embodiment the removal of the separation matrix particles is facilitated (accomplished?) by an external force field. The external force field can typically be a gravitational field (where the matrix particles may settle or float depending on the density), a centrifugal field, a magnetic field, an electric field or a hydrodynamic flow field (as e.g. in removal of the matrix particles by filtration). For gravitational and centrifugal fields, it is possible to use the intrinsic density difference between the separation matrix particles and the surrounding liquid, but it is also possible to include high or low density fillers in the separation matrix particles to increase the density difference. For magnetic fields, it is convenient to include magnetic (e.g. superparamagnetic) fillers in the separation matrix particles.

Other features and advantages of the invention will be apparent from the following examples and from the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### DETAILED DESCRIPTION OF THE DRAWINGS

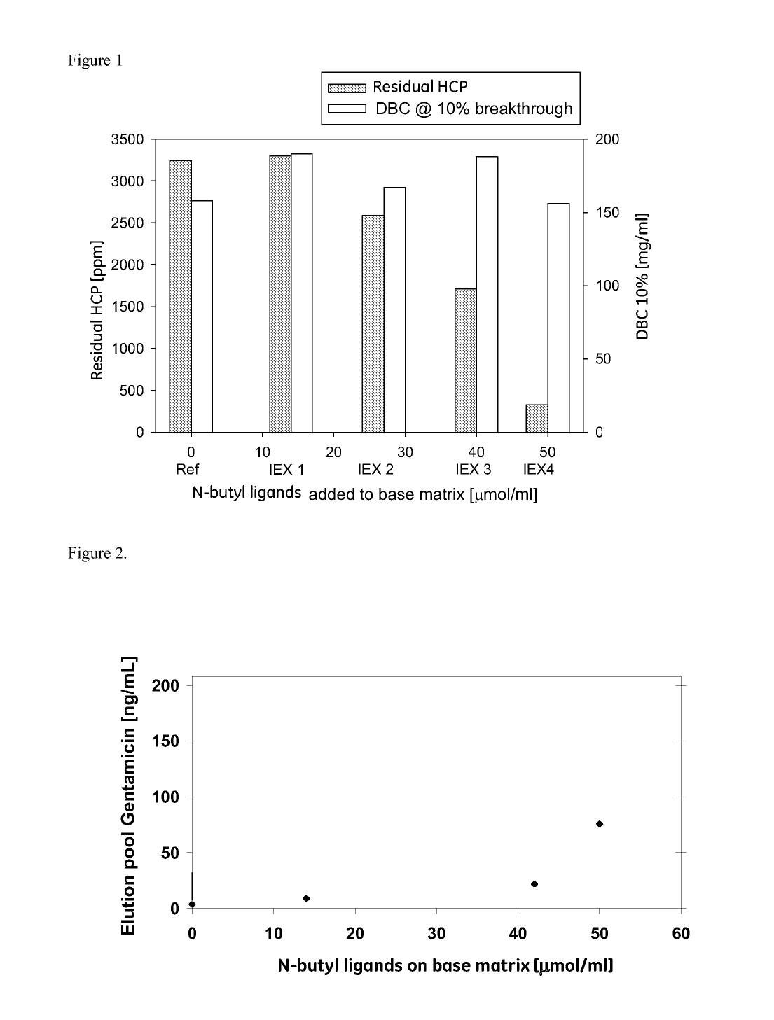

FIG. 1. Dynamic binding capacity for the monoclonal antibody and HCP levels in the cation exchange pool as a function of amount of n-butyl added to base matrix.

FIG. 2. Clearance of Gentamicin (additive in cell cultures) as a function of amount of n-butyl ligands added to base matrix.

### EXAMPLES

Feed Samples

The feed was a protein A column eluate of an IgG monoclonal antibody having its isoelectric point at pH 9.2, expressed in CHO cells. The antibody concentration was approximately 5 g/L, the concentration of host cell proteins was 16 000 ppm and the concentration of Gentamicin (additive in cell culture) was approximately 175 ng/ml. The feed conductivity was adjusted to approximately 4 mS/cm.

### Example 1

### Cation Exchanger Prototypes with n-butyl Ligands on Base Matrix

Agarose gel beads prepared as described in U.S. Pat. No. 6,602,990 (Berg), i.e. agarose having improved flow/pressure properties, were subjected to reaction with n-butyl glycidyl ether by using the conditions described in Synthesis example 1 a) below in order to introduce a controlled hydrophobicity to the matrix. Subsequently an extender was introduced by epoxy activation of the agarose beads and dextran coupling to selected levels using conditions described in Synthesis example 1 b) below. Finally the gel was reacted with sodium vinyl sulphonate according to Synthesis example 1 c) to introduce cation exchange ligands to the desired level.

### Synthesis Example 1

### a) Introduction of Hydrophobic Ligand

The gel (125 grams sedimented) was suspended in water (37.5 mL) and sodium sulphate (20.6 grams) was added followed by stiffing (30 minutes) at room temperature. To the stirred slurry was added a solution of 50% sodium hydroxide (w/w) (37. 5 grams) and sodium borohydride (0.52 gram). The mixture was stirred for 1 hour at room temperature and thereafter butyl glycidyl ether (31.25 mL) was added followed by additional stiffing for 20 hours at 50 ° C. After the reaction was completed water (100 mL) was added and the reaction suspension was neutralized to neutral pH using acetic acid.

Finally the gel was washed on a glass filter using water, ethanol, and then again water.

Analysis of the ligand level introduced using these specific conditions resulted in 50 μmol/mL sedimented gel.

### Synthesis Example 1

### b) Epoxy Activation and Dextran coupling

To gel with introduced hydrophobic ligand (120 grams sedimented) was added water (32.8 mL) and a solution of 50% sodium hydroxide (w/w) (36 mL) where after the slurry was stirred for 20 min at room temperature. Thereafter, using a dosimeter pump, epichloro hydrine (40 mL total, 0.33 mL/minute) was added followed by an additional 2 hours of stirring at room temperature. Finally the gel was washed on a glass filter with water. These conditions resulted in an epoxy activation level of 11 μmol/mL sedimented gel.

Dextran (average molecular weight: 40 kD) (240 grams) dissolved in water (275 mL) to the above prepared gel (110 grams sedimented) followed by stirring at 30 ° C. for 1 hour. Thereafter a solution of 50% sodium hydroxide (w/w) (10.45 mL) and sodium borohydride (0.05 gram) were added followed by stiffing over night (17 hours) at 30 ° C.

These reaction conditions resulted in approximately 29 grams of dextran/mL sedimented gel.

### Synthesis Example 1

### c) Introduction of Sulphonate Ligands

A gel prepared according to above (60 grams sedimented) was washed on a glass filter with 4 times 120 mL of vinyl sulphonic acid sodium salt (30%) (VSA) allowing the last wash to result in a gel plus VSA weight of 120 grams. A 50% sodium hydroxide (w/w) solution (75 mL) was added followed by stiffing at 52° C. during 3.75 hours. Thereafter the gel was washed on a glass filter with water. These conditions resulted in a gel with an ionic ligand density of 99 μmol/mL sedimented gel.

By adjusting the reaction conditions the amount of n-butyl ligands introduced could be controlled in a very precise fashion as indicated by Table 1 below.

TABLE 1

| | | | 50% | | | |
|---|---|---|---|---|---|---|
| | | | NaOH | | Butyl | |
| | | | solution | | glycidyl | Amount of n- |
| Gel | Water | Na2SO4 | (w/w) | NaBH4 | ether | butyl ligands |
| (g) | (g) | (g) | (g) | (g) | (g) | (μmol/ml) |
| 250 | 75 | 41.2 | 75 | 1 | 11.3 | 14 |
| 250 | 75 | 41.2 | 75 | 1 | 25 | 27 |
| 250 | 75 | 41.2 | 75 | 1 | 42.5 | 42 |
| 250 | 75 | 41.2 | 75 | 1 | 62.5 | 50 |

### Example 2

### Dynamic I2G Capacities

The dynamic binding capacity at 10% breakthrough (QB 10%) for the IgG monoclonal antibody was determined using a 20 cm bed height column and a sample residence time of 20 minutes. The columns were equilibrated with 25 mM sodium acetate pH 5.0 before applying the sample. When the loading was completed the column was washed with the equilibration buffer and eluted by a Mobile phase conditions were pH 5 and 4 mS/cm.

### Example 3

### Removal of Impurities with Cation Exchanger Prototypes

The removal of impurities was tested by a similar method as described for the determination of dynamic binding capacity with the exception that the loading of monoclonal antibody was reduced to 130 mg/ml gel, i.e. well below the dynamic breakthrough capacity, to give a more realistic view of the impurity clearance under process conditions. The bound monoclonal antibody was eluted by a conductivity gradient increase to 500 mM sodium acetate. The elution phase was monitored by UV absorbance at 280 nm and the elution pool was collected between optical density (OD) 0.5 on the front and OD 0.5 on the tail of the peak and analyzed for remaining HCP and Gentamicin.

TABLE 2

| | Ionic | Dextran | n-butyl | IgG capacity | Remaining |
|---|---|---|---|---|---|
| Ion | capacity | extender | amount | QB10% | HCP |
| exchanger | (μmol/ml) | (mg/ml) | (μmol/ml) | (mg/ml) | (ppm) |
| Ref | 93 | 20 | 0 | 158 | 3246 |
| 1 | 127 | 29 | 14 | 190 | 3300 |
| 2 | 104 | 31 | 27 | 167 | 2590 |
| 3 | 109 | 28 | 40 | 188 | 1711 |
| 4 | 96 | 26 | 50 | 156 | 330 |

The dynamic IgG capacity and the HCP levels in the cation exchange pool are shown in FIG. 1, as a function of the amount of n-butyl ligands coupled to the base matrix.

FIG. 2 shows the clearance of Gentamicin (additive in cell culture) as a function of the amount of n-butyl ligands coupled to the base matrix.

As can be noted in Table 2 and FIG. 1, higher level of introduced hydrophobicity (n-butyl ligands) leads to reduced levels of HCP contamination in eluted material without losing the high binding capacity. However, the data in FIG. 2 indicates that the removal of other impurities may be negatively affected by too high hydrophobicity levels.

All patents, patent publications, and other published references mentioned herein are hereby incorporated by reference in their entireties as if each had been individually and specifically incorporated by reference herein. While preferred illustrative embodiments of the present invention are described, one skilled in the art will appreciate that the present invention can be practiced by other than the described embodiments, which are presented for purposes of illustration only and not by way of limitation. The present invention is limited only by the claims that follow.

1. Separation matrices comprising base matrices with first ligands comprising hydrophobic functions covalently bound to said base matrices and with extenders covalently bound to said base matrices, said extenders comprising second ion exchange ligands.

2. The separation matrices of claim 1, wherein the ligands comprising hydrophobic functions comprise at least one C₂-C₁₈ hydrocarbon chain or at least one hydrocarbon ring.

3. The separation matrices of claim 1, wherein the extenders comprise polymers of average molecular weight 1000 Da such as over 10 000 Da.

4. The separation matrices of claim 1, wherein the extenders comprise polyhydroxy polymers such as dextran.

5. The separation matrices of claim 1, wherein the base matrices comprise crosslinked polyhydroxy polymers such as polysaccharides.

6. The separation matrices of claim 1, wherein the base matrices comprise agarose or agar.

7. The separation matrices of claim 1, wherein the ion exchange ligands comprise cation exchange ligands such as sulfonate groups.

8. The separation matrices of claim 1, wherein the ligands comprising hydrophobic functions comprise at least one terminal C₂-C₁₈ hydrocarbon chain and/or at least one terminal hydrocarbon ring.

9. The separation matrices of claim 1, wherein the ligands comprising hydrophobic functions comprise butyl, hexyl, octyl or phenyl groups.

10. The separation matrices of claim 1, wherein the extenders comprise less than 5 micromol/g hydrophobic ligands.

11. The separation matrices of claim 1, wherein the amount of ligands comprising hydrophobic functions is 10-100 micromol/ml separation matrix such as 20-70 micromol/ml separation matrix.

12. The separation matrices of claim 1, wherein the ligands comprising hydrophobic functions are attached to the base matrix via linkers comprising ether and hydroxyl groups.

13. The separation matrices of claim 1, wherein the dynamic IgG binding capacity (QB10%) of the separation matrices is ≧100 mg/ml.

14. The separation matrices of claim 1, wherein the separation matrices are in the form of particles such as spherical particles.

15. The separation matrices of claim 1, wherein the separation matrices are in the form of membranes.

16. A method to manufacture separation matrices comprising:
a) coupling first ligands comprising hydrophobic functions to base matrices; and
b) coupling extenders comprising second ion exchange ligands to said base matrices.

17. A method to manufacture separation matrices comprising:
a′) coupling first ligands comprising hydrophobic functions to base matrices;
b′) coupling extenders to said base matrices and
c′) coupling second ion exchange ligands to said extenders.

18. The method of claim 16, wherein the ligands comprising hydrophobic functions are coupled to the base matrices before coupling of the extenders.

19. A method to manufacture separation matrices comprising:
a″) coupling ligands comprising hydrophobic functions to base matrices; and
b″) grafting polymerizing monomers comprising charged monomers to said base matrices.

20. The method of claim 16, wherein the ligands comprising hydrophobic functions are coupled to the base matrices by reacting the base matrices with alkyl or alkylaryl glycidyl ethers.

21. A method to separate at least one target biomolecule from a liquid preparation, which includes a step of contacting said liquid preparation with separation matrices comprising first ligands comprising hydrophobic functions covalently bound to the base matrices and extenders comprising second ion exchange ligands.

22. The method of claim 21, wherein said base matrices comprise agarose.

23. The method of claim 21, wherein said extenders comprise dextran.

24. The method of claim 21, wherein said ion exchange ligands comprise cation exchange ligands.

25. The method of claim 21, wherein said target biomolecule is a protein such as an antibody.

26. The method of claim 25, wherein the protein is a monoclonal IgG antibody.

27. The method of claim 21, wherein the target biomolecule binds to the separation matrices while non-binding/less strongly bound impurities are washed or desorbed from the matrices before contacting the matrices with a desorption liquid to desorb the target biomolecule.

28. The method of claim 27, wherein the desorption liquid has a different conductivity and/or pH than the binding buffer and the washing buffer.

29. The method of claim 28, wherein the desorption liquid has a higher conductivity than the binding buffer and the washing buffer.

30. The method of claim 21, wherein the liquid preparation contains host cell proteins.

31. The method of claim 30, wherein the host cell protein concentration is reduced by a factor of ≧5.

32. The method of claim 21, wherein the separation matrices are packed in a column

33. The method of claim 32, wherein the impurities bind to the separation matrices, while the target biomolecule is recovered in the flow-through of the column.

34. The method of claim 21, wherein a suspension of separation matrix particles is contacted with the liquid preparation and the separation matrix particles are subsequently removed from the liquid preparation.

35. The method of claim 34, wherein the removal of the separation matrix particles is facilitated by an external force field
